(19) United States
(12) Patent Application Publication
(10) Pub. No.: US 2021/0029875 A1
(43) Pub. Date: Feb. 4, 2021

(54) LAWN MOWER

(71) Applicant: Makita Corporation, Anjo-shi (JP)

(72) Inventor: Noriaki Takahashi, Anjo-shi (JP)

(73) Assignee: Makita Corporation, Anjo-shi (JP)

(21) Appl. No.: 16/944,386

(22) Filed: Jul. 31, 2020

(30) Foreign Application Priority Data
Aug. 2, 2019 (JP) 2019-143049

(51) Int. Cl. A01D 34/68; A01D 34/78; A01D 43/063; A01D 34/82

(52) U.S. Cl. CPC A01D 34/6806; A01D 34/78; A01D 2101/00; A01D 34/824; A01D 43/0638

(57) ABSTRACT

A lawn mower may include: a cutter unit including a cutter configured to cut grass on a ground and a motor configured to drive the cutter; a handle unit attached to the cutter unit and configured to be gripped by an operator; a grass collection container attached to the handle unit and configured to collect the grass cut by the cutter; and a battery configured to supply electric power to the motor. In a side view of the lawn mower, the battery may be disposed on a same side as the cutter unit with respect to the handle unit.

### CROSS-REFERENCE TO RELATED APPLICATION

This application claims priority to Japanese Patent Application No. 2019-143049, filed on Aug. 2, 2019, the entire contents of which are hereby incorporated by reference into the present application.

### TECHNICAL FIELD

This disclosure herewith relates to a lawn mower.

### BACKGROUND

Japanese Patent Application Publication No. 2009-118823 describes a lawn mower. This lawn mower comprises a cutter unit, a handle unit, a grass collection container, and a power cable. The cutter unit comprises a cutter configured to cut grass on a ground and a motor configured to drive the cutter. The handle unit is attached to the cutter unit and is configured to be gripped by an operator. The grass collection container is attached to the handle unit and is configured to collect the grass cut by the cutter. When the power cable is connected to an external power supply, electric power is supplied to the motor.

### SUMMARY

In a lawn mower such as the above, the cutter may be lifted upward from the ground during mowing work, which may result in a poor mowing result, for example. The disclosure herein discloses a technique that suppresses a cutter from being lifted upward from a ground during mowing work.

The disclosure herein discloses a lawn mower. The lawn mower may comprise a cutter unit, a handle unit, a grass collection container, and a battery. The cutter unit may comprise a cutter configured to cut grass on a ground and a motor configured to drive the cutter. The handle unit may be attached to the cutter unit and configured to be gripped by an operator. The grass collection container may be attached to the handle unit and configured to collect the grass cut by the cutter. The battery may be configured to supply electric power to the motor. In a side view of the lawn mower, the battery may be disposed on a same side as the cutter unit with respect to the handle unit.

In the above configuration, the battery is disposed on the same side as the cutter unit with respect to the handle unit in the side view of the lawn mower, thus stress corresponding to the weight of the battery is imparted to the cutter during mowing work. Therefore, even when a force that causes the cutter to lift up from the ground is applied to the cutter during mowing work, upward lifting of the cutter from the ground can be suppressed.

### BRIEF DESCRIPTION OF DRAWINGS

FIG. 1 is a perspective view of a lawn mower 2 according to an embodiment.

FIG. 2 is a cross-sectional view of an area around a cutter unit 4 of the lawn mower 2 according to the embodiment.

FIG. 3 is a cross-sectional view of the lawn mower 2 according to the embodiment.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved lawn mowers, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, in atop view of a lawn mower, a battery at least partially overlaps a cutter.

In a case where the battery does not overlap the cutter in the top view of the lawn mower, application of a force that causes the cutter to lift upward from the ground may cause the cutter unit to tilt, which may result in upward lifting of the cutter. The above-described configuration can further suppress the upward lifting of the cutter from the ground, as compared to the configuration in which the battery does not overlap the cutter in the top view of the lawn mower.

In one or more embodiments, in a side view of the lawn mower, a grass collection container may be disposed on an opposite side to a cutter unit with respect to a handle unit.

In a case where the grass collection container is disposed on the same side as the cutter unit with respect to the handle unit in the side view of the lawn mower, the grass collection container has to be designed depending on the shape of the cutter unit. The above configuration allows any design for the grass collection container, independent of the shape of the cutter unit.

In one or more embodiments, the cutter unit may further comprise a contact member configured to contact the ground in a state where the lawn mower is placed on the ground. In a top view of the lawn mower, the battery may at least partially overlap the contact member.

In a case where the battery does not overlap the contact member in the top view of the lawn mower, application of a force that causes the contact member to lift upward from the ground may cause the cutter unit to tilt, which may result in upward lifting of the contact member. The above-described configuration can suppress the upward lifting of the contact member, as compared to the configuration in which the battery does not overlap the contact member in the top view of the lawn mower. Since the configuration can suppress the upward lifting of the contact member, it can further suppress the upward lifting of the cutter from the ground.

In one or more embodiments, the grass collection container may include a collection hole through which the grass cut by the cutter is collected into the grass collection container. The collection hole may be located in an upper portion of the grass collection container in a state where the lawn mower is placed on the ground.

The grass cut by the cutter accumulates in the grass collection container from its bottom toward upper portion. When there is accumulation of some grass in the grass collection container already, the grass cut by the cutter accumulates on top of the existing accumulation of grass. Since the collection hole is located in the upper portion of the grass collection container in the above configuration, the collection hole is less likely to be clogged by the grass, as compared to a configuration in which the collection hole is located in a central portion or a lower portion of the grass collection container. Thus, disposal of the grass in the grass collection container can be less frequent.

In one or more embodiments, the cutter unit may further comprise a housing that houses the battery.

The above configuration can protect the battery by the housing.

In one or more embodiments, the battery may be detachably attached to the cutter unit.

When the battery runs out of charge, the above configuration enables the operator to remove only the battery from the cutter unit to recharge it.

In one or more embodiments, the lawn mower may further comprise a pair of wheels rotatably attached to the cutter unit.

The above configuration allows the operator to easily move the lawn mower around.

In one or more embodiments, the handle unit may be swingably attached to the cutter unit.

The above configuration improves mowing work performance.

### Embodiment

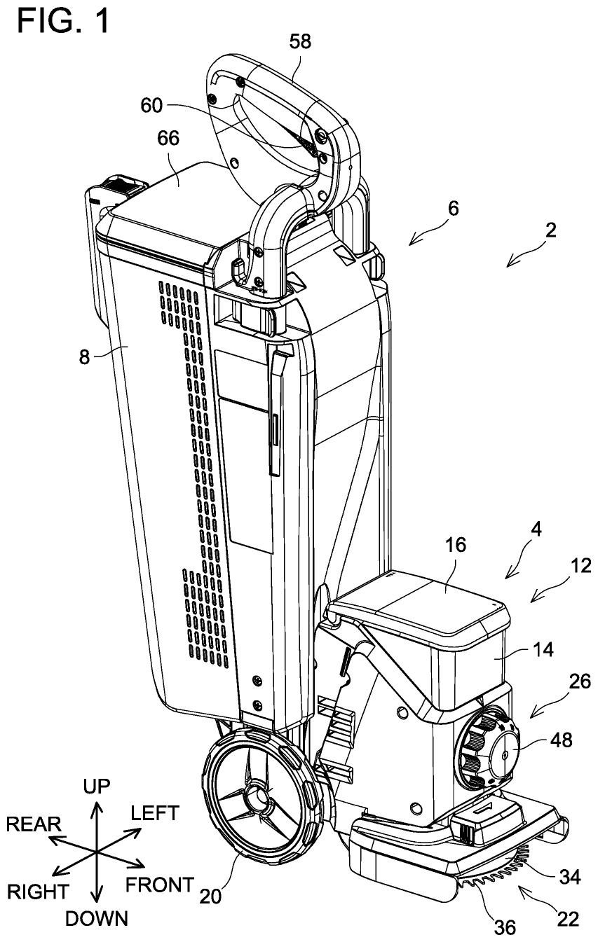

With reference to FIGS. 1 to 3, a lawn mower 2 according to an embodiment will be described. The lawn mower 2 is a working machine for gardening. The lawn mower 2 is mainly used for lawn mowing work. Although the lawn mower 2 of the present embodiment is a push mower configured to be operated by a user, the lawn mower 2 may be a lawn mower that is at least partially self-propelled in another embodiment.

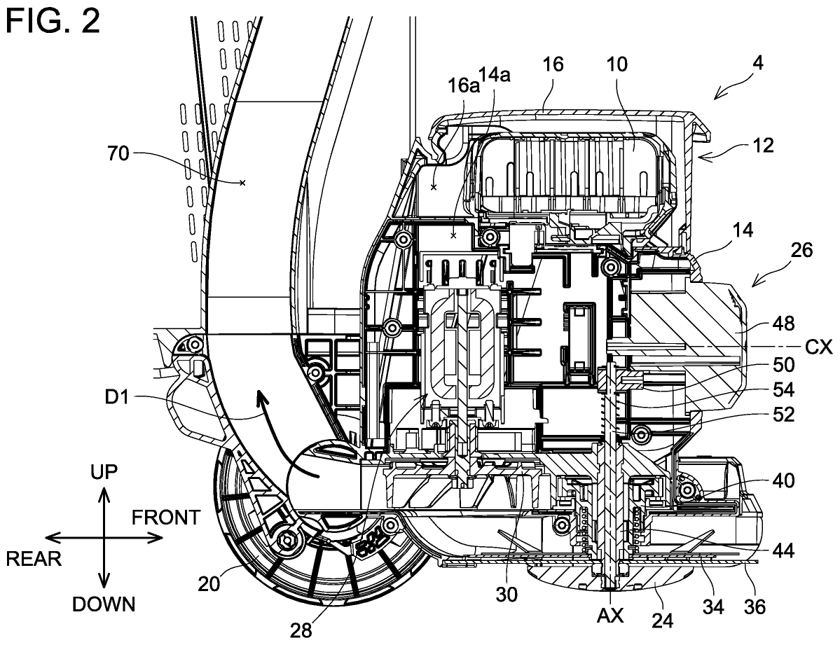

As shown in FIG. 1, the lawn mower 2 comprises a cutter unit 4, a handle unit 6, a grass collection container 8, and a battery 10 (see FIG. 2). As shown in FIG. 2, the cutter unit 4 comprises a housing 12, a pair of wheels 20, a cutter 22, a rotation shaft 40, a fixed shaft 44, a contact member 24, a height adjustment mechanism 26, a motor 28, and a fan 30. The housing 12 comprises a base 14 and a cover 16. The base 14 defines a first space 14a therein. The cover 16 is attached to an upper end of the base 14 and configured to be opened and closed. With the cover 16 closed, a second space 16a is defined between the cover 16 and the base 14. The pair of wheels 20 is rotatably attached to a lower rear end of the base 14 of the housing 12. This allows the user to easily move the lawn mower 2 around by manually pushing the lawn mower 2. Hereinbelow, in a state where the lawn mower 2 is placed on the ground, a direction perpendicular to the ground will be termed an up-down direction, a direction along which the pair of wheels 20 moves (i.e., traveling direction, retreat direction) will be termed a front-rear direction, and a direction perpendicular to the up-down direction and the front-rear direction will be termed a right-left direction.

The cutter 22 is attached to a bottom of the housing 12 to face grass on the ground. The cutter 22 is a member configured to cut the grass on the ground. The cutter 22 is constituted of metal or resin, for example. The cutter 22 comprises a rotary blade 34 and a fixed blade 36. As shown in FIG. 2, a lower surface of the rotary blade 34 faces an upper surface of the fixed blade 36. The rotary blade 34 is attached to the rotation shaft 40, while the fixed blade 36 is attached to the fixed shaft 44. The rotation shaft 40 is rotatable about a center axis AX extending in the up-down direction and is rotatably held by the fixed shaft 44. Rotation of the rotation shaft 40 about the center axis AX causes the rotary blade 34 to rotate. The grass that has been caught by cutting edges of the non-rotatable fixed blade 36 is cut by the fixed blade 36 and the rotary blade 34.

The contact member 24 is disposed below the fixed shaft 44. The contact member 24 is configured to contact the ground during mowing work. The lawn mower 2 is supported on the ground at three points, which are the contact member 24 and the pair of wheels 20. The contact member 24 is disposed below the fixed blade 36. In a top view of the lawn mower 2, the contact member 24 partially overlaps the cutter 22.

The height adjustment mechanism 26 is configured to adjust a distance between the contact member 24 and the bottom of the housing 12, that is, a distance between the bottom of the housing 12 and the ground. The height adjustment mechanism 26 comprises an adjustment dial 48, a conversion member 50, a support shaft 52, and a bias member 54. The adjustment dial 48 is attached to a front surface of the base 14 of the housing 12. The adjustment dial 48 is configured to be rotated by the operator about a center axis CX extending in the front-rear direction.

The conversion member 50 is in contact with a rear portion of the adjustment dial 48. The conversion member 50 is coupled to the support shaft 52 near an upper end of the support shaft 52. The conversion member 50 is configured to convert a rotational movement of the adjustment dial 48 about the center axis CX to an up-down movement of the support shaft 52.

The support shaft 52 is inserted in the fixed shaft 44. The support shaft 52 is configured to slide in the up-down direction relative to the fixed shaft 44. A lower end of the support shaft 52 is fitted to the contact member 24. The support shaft 52 is biased by the bias member 54 in a direction along which the support shaft 52 is moved upward relative to the fixed shaft 44.

Rotation of the adjustment dial 48 in a first direction about the center axis CX causes the support shaft 52 to move downward relative to the fixed shaft 44 according to the movement conversion function of the conversion member 50. This causes the contact member 24 to move away from the bottom of the housing 12. As a result, the bottom of the housing 12 moves away from the ground. On the contrary, the rotation of the adjustment dial 48 in a second direction, which is opposite to the first direction about the center axis CX, causes the support shaft 52 to move upward relative to the fixed shaft 44 by being biased by the bias member 54. This causes the contact member 24 to move closer to the bottom of the housing 12. As a result, the bottom of the housing 12 moves closer to the ground.

The motor 28 and the fan 30 are housed in the first space 14a of the housing 12. The motor 28 is a brushless motor, for example. Actuation of the motor 28 causes the rotation shaft 40 to rotate about the center axis AX. The rotary blade 34 is thereby rotated.

The fan 30 is driven by the motor 28. The fan 30 is configured to cool the motor 28. Further, the fan 30 generates an air flow D1 that discharges the grass cut by the cutter 22 toward the grass collection container 8.

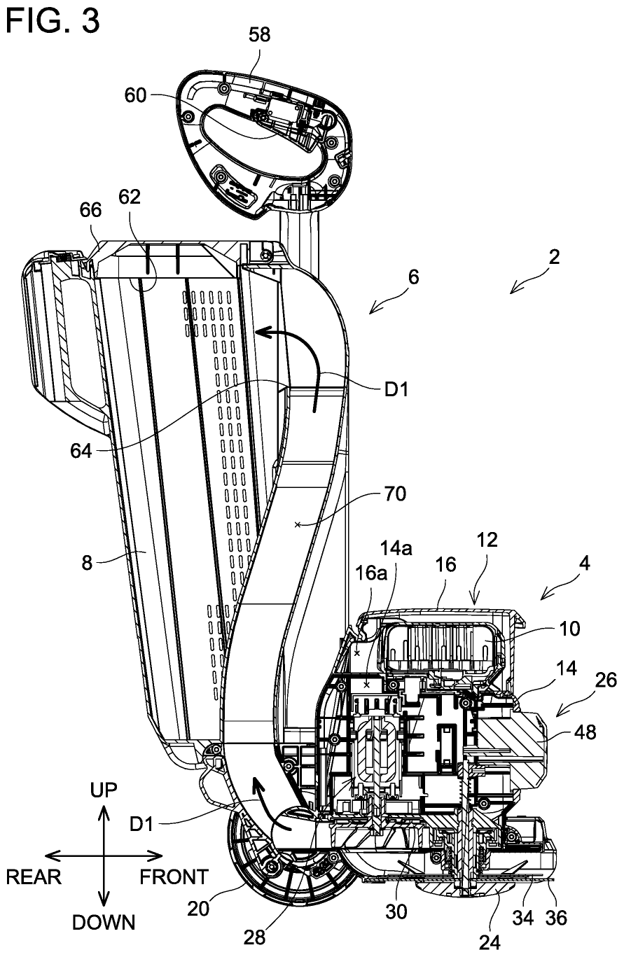

As shown in FIG. 3, the handle unit 6 extends upward from an upper rear portion of the cutter unit 4. The handle unit 6 is swingable with respect to the cutter unit 4. An axis of the handle unit 6 is parallel to a rotation axis of the pair of wheels 20. An operation grip 58 is disposed at a top portion of the handle unit 6. The operation grip 58 is configured to be gripped by the operator. Normally, the operator stands behind the lawn mower 2 and grips the operation grip 58 to operate the lawn mower 2. The operation grip 58 includes a trigger switch 60. The trigger switch 60 is a switch for actuating the motor 28. The trigger switch 60 is electrically connected to the motor 28 and is configured to supply electric power to the motor 28 while the operator operates the trigger switch 60 to drive the cutter 22.

The grass collection container 8 is detachably attached to a rear portion of the handle unit 6. The grass collection container 8 is configured to house grass cut by the cutter 22. In a side view of the lawn mower 2 (i.e., when the lawn mower 2 is viewed from the left or the right), the grass collection container 8 is disposed on the opposite side to the cutter unit 4 with respect to the handle unit 6. The grass collection container 8 includes a discharge hole 62 and a collection hole 64. The discharge hole 62 is located at an upper end of the grass collection container 8. The discharge hole 62 is an opening through which the grass accumulated in the grass collection container 8 is discharged to the outside of the grass collection container 8. The discharge hole 62 is closed by a cover 66, with the grass collection container 8 attached to the handle unit 6. The collection hole 64 is located in an upper portion of the grass collection container 8. The collection hole 64 is an opening through which the grass cut by the cutter 22 is collected into the grass collection container 8.

The lawn mower 2 further comprises a grass collection duct 70. The grass collection duct 70 is configured to guide the grass cut by the cutter 22 to the grass collection container 8. The grass collection duct 70 extends in both the cutter unit 4 and the handle unit 6. Most part of the grass collection duct 70 is disposed in the handle unit 6. The grass collection duct 70 extends upward from the cutter unit 4 and is connected to the collection hole 64 of the grass collection container 8. As described above, the cutter unit 4 comprises the fan 30 that is driven by the motor 28. The fan 30 is not only configured to cool the motor 28, but also is configured to generate the air flow D1 that carries the grass within the grass collection duct 70. The grass-carrying air flows in the grass collection duct 70 toward the collection hole 64 of the grass collection container 8.

The battery 10 is housed in the second space 16a of the housing 12. The battery 10 is detachably attached to the base 14 of the housing 12. The battery 10 is attached to the base 14 with the cover 16 open and then the cover 16 is closed, as a result of which the battery 10 is housed in the second space 16a. The battery 10 is a lithium-ion battery, for example. The battery 10 is configured to supply electric power to the motor 28. This rotates the rotation shaft 40 about the center axis AX by the motor 28, which results in rotation of the rotary blade 34. In the side view of the lawn mower 2, the battery 10 is disposed on the same side as the cutter unit 4 and on the opposite side to the grass collection container 8 with respect to the handle unit 6. In the side view of the lawn mower 2, the battery 10 is disposed frontward of the grass collection container 8 and the pair of wheels 20. In the top view of the lawn mower 2, the battery 10 overlaps the cutter 22 and the contact member 24.

In the present embodiment, the pair of wheels 20 is attached to the housing 12, thus the lawn mower 2 can make sharp turns. On the contrary, when a force that causes the cutter 22 to lift upward from the ground is applied to the cutter 22 during mowing work with the lawn mower 2 due to, for example, a small stone and the like being caught in the cutter 22, the cutter unit 4 may thereby rotate in the direction along which the pair of wheels 20 rotates about its rotational axis and the cutter 22 may be lifted upward as a result. As compared to a lawn mower in which the pair of wheels 20 is attached to each of front and rear ends of the housing 12, the cutter 22 is prone to being lifted upward from the ground. However, in the present embodiment, the battery 10 is disposed on the same side as the cutter unit 4 with respect to the handle unit 6. Thus, not only stress corresponding to the weight of the cutter unit 4, but also stress corresponding to the weight of the battery 10 is imparted to the cutter 22. Therefore, the lawn mower 2 according to the present embodiment suppresses the upward lifting of the cutter 22, as compared to a lawn mower that does not include the battery 10.

The lawn mower 2 according to the present embodiment comprises the cutter unit 4, the handle unit 6, the grass collection container 8, and the battery 10. The cutter unit 4 comprises the cutter 22 configured to cut grass on a ground and the motor 28 configured to drive the cutter 22. The handle unit 6 is attached to the cutter unit 4 and configured to be gripped by an operator. The grass collection container 8 is attached to the handle unit 6 and configured to collect the grass cut by the cutter 22. The battery 10 is configured to supply electric power to the motor 28. In a side view of the lawn mower 2, the battery 10 is disposed on the same side as the cutter unit 4 with respect to the handle unit 6. In this configuration, the battery 10 is disposed on the same side as the cutter unit 4 with respect to the handle unit 6 in the side view of the lawn mower 2, thus stress corresponding to the weight of the battery 10 is imparted to the cutter 22 during mowing work. Therefore, even when a force that causes the cutter 22 to lift up from the ground is applied to the cutter 22 during mowing work, upward lifting of the cutter 22 from the ground can be suppressed.

In a top view of the lawn mower 2, the battery 10 at least partially overlaps the cutter 22. In a case where the battery 10 does not overlap the cutter 22 in the top view of the lawn mower 2, application of a force that causes the cutter 22 to lift upward from the ground to the cutter 22 may cause the cutter unit 4 to tilt, which may result in upward lifting of the cutter 22. The above-described configuration can further suppress the upward lifting of the cutter 22 from the ground, as compared to the configuration where the battery 10 does not overlap the cutter 22 in the top view of the lawn mower 2.

In a side view of the lawn mower 2, the grass collection container 8 is disposed on the opposite side to the cutter unit 4 with respect to the handle unit 6. In a case where the grass collection container 8 is disposed on the same side as the cutter unit 4 with respect to the handle unit 6 in the side view of the lawn mower 2, the grass collection container 8 has to be designed depending on the shape of the cutter unit 4. The above configuration allows any design for the grass collection container 8, independent of the shape of the cutter unit 4.

The cutter unit 4 further comprises the contact member 24 configured to contact the ground in a state where the lawn mower 2 is placed on the ground. In a top view of the lawn mower 2, the battery 10 at least partially overlaps the contact member 24. In a case where the battery 10 does not overlap the contact member 24 in the top view of the lawn mower 2, application of a force that causes the contact member 24 to lift upward from the ground to the contact member 24 may cause the cutter unit 4 to tilt, which may result in upward lifting of the contact member 24. The above-described configuration can suppress the upward lifting of the contact member 24, as compared to the configuration where the battery 10 does not overlap the contact member 24 in the top view of the lawn mower 2. Since the configuration can suppress the upward lifting of the contact member 24, it can further suppress the upward lifting of the cutter 22 from the ground.

The grass collection container 8 includes the collection hole 64 through which the grass cut by the cutter 22 is collected into the grass collection container 8. The collection hole 64 is located in an upper portion of the grass collection container 8 in a state where the lawn mower 2 is placed on the ground. The grass cut by the cutter 22 accumulates in the grass collection container 8 from its bottom to upper portion. When there is accumulation of some grass in the grass collection container 8 already, the grass cut by the cutter 22 accumulates on top of the accumulation of grass. Since the collection hole 64 is located in the upper portion of the grass collection container 8 in the above configuration, the collection hole 64 is less likely to be closed by the grass, as compared to a configuration where the collection hole 64 is located in a central portion or a lower portion of the grass collection container 8. Thus, disposal of the grass in the grass collection container 8 can be less frequent.

The cutter unit 4 further comprises the housing 12 that houses the battery 10. This configuration can protect the battery 10 by the housing 12.

The battery 10 is detachably attached to the cutter unit 4. When the battery 10 runs out of charge, this configuration enables the operator to remove only the battery 10 from the cutter unit 4 to recharge it.

The lawn mower 2 further comprises the pair of wheels 20 rotatably attached to the cutter unit 4. This configuration allows the operator to easily move the lawn mower 2 around.

The handle unit 6 is swingably attached to the cutter unit 4. This configuration improves mowing work performance.

In an embodiment, the battery 10 may not overlap the cutter 22 and/or may not overlap the contact member 24 in the top view of the lawn mower 2.

In an embodiment, the collection hole 64 may be located at a central portion or at a lower portion of the grass collection container 8 with respect to the up-down direction.

In an embodiment, the battery 10 may not be housed in the housing 12. The battery 10 may be attached to an upper portion or a side surface of the housing 12. In this case, the battery 10 may be detachably attached to the housing 12 by being slid relative to the housing 12.

In an embodiment, the battery 10 of the lawn mower 2 may be built in the housing 12. In this case, the battery 10 cannot be removed from the housing 12, thus a cable connected to an external power supply is connected to the battery 10 to recharge the battery 10.

In an embodiment, the cutter unit 4 may not comprise the pair of wheels 20, and the handle unit 6 may comprise the pair of wheels 20. Further, the lawn mower 2 may not comprise the wheels 20.

In an embodiment, the handle unit 6 may not be swingably attached to the cutter unit 4.

In an embodiment, the cutter 22 may be a scythe cutter.

What is claimed is:

1. A lawn mower comprising:
a cutter unit comprising a cutter configured to cut grass on a ground and a motor configured to drive the cutter;
a handle unit attached to the cutter unit and configured to be gripped by an operator;
a grass collection container attached to the handle unit and configured to collect the grass cut by the cutter; and
a battery configured to supply electric power to the motor,
wherein
in a side view of the lawn mower, the battery is disposed on a same side as the cutter unit with respect to the handle unit.

2. The lawn mower according to claim 1, wherein in a top view of the lawn mower, the battery at least partially overlaps the cutter.

3. The lawn mower according to claim 1, wherein in the side view of the lawn mower, the grass collection container is disposed on an opposite side to the cutter unit with respect to the handle unit.

4. The lawn mower according to claim 1, wherein
the cutter unit further comprises a contact member configured to contact the ground in a state where the lawn mower is placed on the ground, and
in a top view of the lawn mower, the battery at least partially overlaps the contact member.

5. The lawn mower according to claim 1, wherein
the grass collection container includes a collection hole through which the grass cut by the cutter is collected into the grass collection container, and
the collection hole is located in an upper portion of the grass collection container in a state where the lawn mower is placed on the ground.

6. The lawn mower according to claim 1, wherein the cutter unit further comprises a housing that houses the battery.

7. The lawn mower according to claim 1, wherein the battery is detachably attached to the cutter unit.

8. The lawn mower according to claim 1, further comprising a pair of wheels rotatably attached to the cutter unit.

9. The lawn mower according to claim 1, wherein the handle unit is swingably attached to the cutter unit.
